(19) United States
(12) Patent Application Publication
(10) Pub. No.: US 2022/0373863 A1
(43) Pub. Date: Nov. 24, 2022

(54) PHOTOGRAPHING GLASSES

(71) Applicant: Lanto Electronic Limited, Kunshan City (CN)

(72) Inventors: Fu-Yuan WU, Taipei City (TW); Tao-Chun CHEN, Taipei City (TW)

(73) Assignee: Lanto Electronic Limited, Kunshan City (CN)

(21) Appl. No.: 17/583,716

(22) Filed: Jan. 25, 2022

(30) Foreign Application Priority Data
May 24, 2021 (CN) 202110566051.0

(51) Int. Cl. G03B 11/04; G02C 11/00

(52) U.S. Cl. CPC G03B 11/043; G02C 11/10

(57) ABSTRACT

A photographing glasses including a frame and an image capturing module is provided. The frame includes a first end, a second end, and a connecting portion. The image capturing module is disposed at the first end or the second end. The image capturing module includes a camera unit and a lens switch. The lens switch includes a shielding element, and the shielding element is movably disposed on a side of the camera unit. While the lens switch is in an open state, the camera unit is exposed by the shielding element. While the lens switch is in a closed state, the camera unit is blocked by the shielding element.

### CROSS REFERENCE TO RELATED APPLICATION

This application claims the priority benefit of Chinese Patent Application Serial Number 202110566051.0, filed on May 24, 2021, the full disclosure of which is incorporated herein by reference.

### BACKGROUND

### Technical Field

The present disclosure relates to the technical field of glasses, particularly to a photographing glasses.

### Related Art

The development of miniaturized electronic components has brought a new look to many portable products. For example, the thickness and weight of mobile devices such as cell phones, laptops, and tablets can be reduced, but the computing performance is more powerful.

Nowadays, there is a kind of photographing glasses, in which an image capturing module is configured to a frame of the glasses, so that a user can take images he is watching while wearing the glasses. The photographing glasses can be used as a recording device, for example, for police or security personnel to record when they are on duty, or for drivers when driving or riding a bicycle. In addition, there is now a smart glasses, which not only has a camera unit, but also has the function of image recognition and control. The smart glasses can recognize images viewed by a user in real time and analyze them simultaneously to provide corresponding information for the user's reference. For example, the smart glasses may have an image capturing module to receive images of a flower viewed by the user and to analyze them in real time to provide information such as the name of the flower, the growing season, and the flower meaning to the user. In addition, the smart glasses can also optionally have video and audio output functions, so that the user can obtain corresponding information without taking out the mobile device to query the case.

After considering factors such as size, endurance, and computing power consumption, the smart glasses that are currently well-known to the public share computing resources through the connection with personal mobile devices, so that they can have a lighter volume and longer endurance.

However, an image capturing module of current photographing glasses or smart glasses is not equipped with a lens switch, so when the user wears the smart glasses, the surrounding people cannot determine whether the image capturing module is in operation. As a result, personal information such as appearance, clothing, transportation, etc. may be arbitrarily disclosed, which raises the suspicion of privacy infringement.

In view of this, how to provide a photographing glasses that enables the lens switch to be turned on and off by manual control or automatic control, to avoid the privacy infringement concerns that may be caused by improperly receiving surrounding images is a problem that needs to be solved urgently in the industry.

### SUMMARY

The embodiments of the present disclosure provide a photographing glasses to solve the privacy infringement problem that may be caused by the current photographing glasses being unable to cover an image capturing module during wearing.

One embodiment of the disclosure provides a photographing glasses, which comprises:

a frame comprising a first end, a second end, and a connecting portion, wherein the second end is disposed opposite to the first end, and the connecting portion is configured to connect the first end and the second end; and

an image capturing module disposed at the first end, the second end, or the connecting portion of the frame;

wherein the image capturing module comprises a camera unit and a lens switch, the lens switch comprises a shielding element, and the shielding element is movably disposed on a side of the camera unit, while the lens switch is in an open state, the camera unit is exposed by the shielding element; and while the lens switch is in a closed state, the camera unit is blocked by the shielding element.

In the photographing glasses of present disclosure, while the lens switch is in the open state, the camera unit is exposed by the shielding element in a viewing direction of a user, and the camera unit is configured to receive images from the viewing direction of the user; while the lens switch is in the closed state, the camera unit is blocked by the shielding element in the viewing direction of the user, and the camera unit is blocked and cannot receive the image from the viewing direction of the user.

In another embodiment of the photographing glasses of present disclosure, the image capturing module comprises a main portion, the main portion is connected to a side of the first end, and the camera unit and the lens switch are disposed in the main portion.

In another embodiment of the photographing glasses of present disclosure, the main portion comprises an opening, the camera unit is aligned with the opening, and the shielding element is movably disposed between the opening and the camera unit.

In another embodiment of the photographing glasses of present disclosure, the shielding element moves between the opening and the camera unit in a lateral displacement manner.

In another embodiment of the photographing glasses of present disclosure, the main portion further comprises a connecting section and a bending section, the connecting section is connected to a side of the first end, the bending section is bent from the connecting section and extends to a side close to the connecting portion, the opening is provided on the bending section, and the camera unit and the lens switch are disposed on an inner side of the bending section.

In another embodiment of the photographing glasses of present disclosure, the main portion further comprises a lens disposed in the opening.

In another embodiment of the photographing glasses of present disclosure, thicknesses of two sides of the lens are not equal.

In another embodiment of the photographing glasses of present disclosure, the image capturing module comprises a trigger unit, when the user presses the trigger unit, the trigger unit drives the lens switch to switch between the open state and the closed state.

In another embodiment of the photographing glasses of present disclosure, the image capturing module further comprises a trigger unit and a driving module, the trigger unit is configured to generate a signal, the driving module is configured to receive the signal to drive the lens switch to switch between the open state and the closed state.

In another embodiment of the photographing glasses of present disclosure, the photographing glasses further comprises an information display module, wherein the information display module extends from the main portion and is disposed on a side close to the connecting portion.

In another embodiment of the embodiment of the present disclosure, the lens switch is set to switch between the closed state and the open state, so as to control whether the image capturing module can receive the images from the viewing direction of the user, thereby avoiding privacy disputes.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The accompanying drawings illustrated herein are used to provide a further understanding of the present disclosure and form part of the present disclosure. The exemplary embodiments of the present disclosure and the description thereof are used to explain the present disclosure and do not constitute an undue limitation of the present disclosure.

FIG. 1 is a perspective view of a photographing glasses of the present disclosure.

FIG. 2 is a schematic view of a camera unit and a lens switch of the photographing glasses of the present disclosure disposed in an inner side of a main portion.

FIG. 3 is a top view of the camera unit and the lens switch of the photographing glasses of the present disclosure disposed in the inner side of the main portion.

FIG. 4 is a schematic view of relative positions of the camera unit, the lens switch and an opening of the photographing glasses of the present disclosure, and the lens switch is in an open state.

FIG. 5 is a schematic view of the relative positions of the camera unit, the lens switch and the opening of the photographing glasses of the present disclosure, and the lens switch is in a closed state.

### DETAILED DESCRIPTION OF THE EMBODIMENTS

The technical solution in the embodiments of the present disclosure will be clearly and completely described below with reference to the accompanying drawings in the embodiments of the present disclosure. It is to be understood that the described embodiments are merely exemplary of the invention, and not restrictive of the full scope of the invention. All other embodiments, which can be obtained by a person skilled in the art without inventive step based on the embodiments of the present disclosure, are within the scope of the present disclosure.

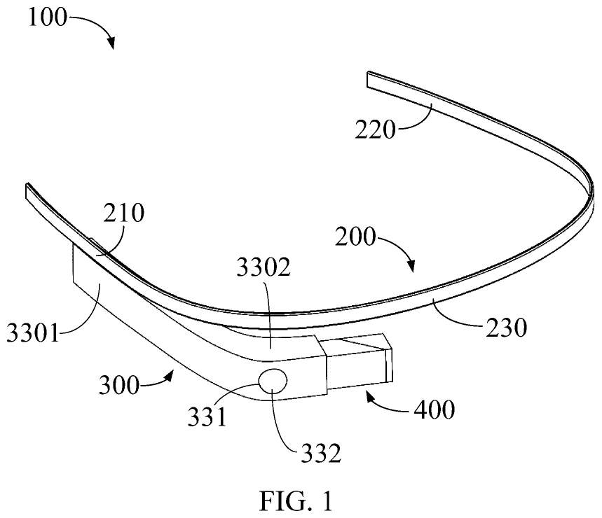

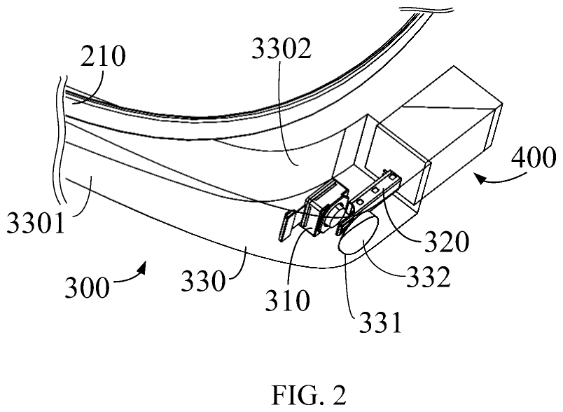

Please refer to FIG. 1 and FIG. 2 together. A photographing glasses 100 of the present disclosure can be worn by a user to capture and record images viewed by the user. In some embodiments, the photographing glasses 100 may be glasses that only have a function of capturing images or may be smart glasses with image recognition and control functions. The photographing glasses 100 comprises a frame 200 and an image capturing module 300. The frame 200 comprises a first end 210, a second end 220, and a connecting portion 230. The second end 220 is disposed opposite to the first end 210, and the connecting portion 230 is configured to connect the first end 210 and the second end 220. In one embodiment shown in the drawings, the image capturing module 300 is disposed at the first end 210 of the frame 200, but this is not a limitation. In other words, in other embodiments, the image capturing module 300 may also be disposed at the second end 220 or the connecting portion 230.

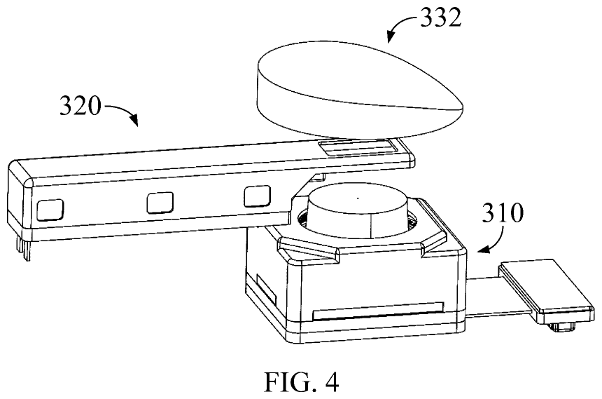

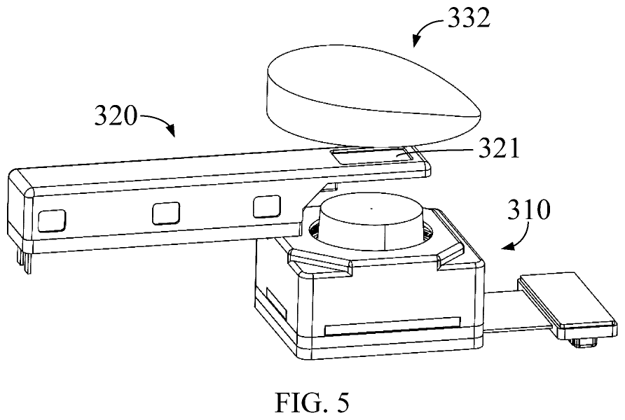

The image capturing module 300 comprises a camera unit 310 and a lens switch 320. The lens switch 320 comprises a shielding element 321, and the shielding element 321 is movably disposed on a side of the camera unit 310. As shown in FIG. 4, while the lens switch 320 is in an open state, the camera unit 310 is exposed by the shielding element 321. As shown in FIG. 5, while the lens switch 320 is in a closed state, the camera unit 310 is blocked by the shielding element 321. In some embodiments, as shown in FIG. 4, while the lens switch 320 is in the open state, the camera unit 310 is exposed by the shielding element 321 in a viewing direction of the user (up and down direction in FIG. 4), so that the camera unit 310 can be configured to receive images from the viewing direction of the user. As shown in FIG. 5, while the lens switch 320 is in the closed state, the camera unit 310 is blocked by the shielding element 321 in the viewing direction of the user (up and down direction in FIG. 5), so that the camera unit 310 is blocked and cannot receive the images from the viewing direction of the user.

Please continue to refer to FIG. 1 and FIG. 2. In the photographing glasses 100 of the present disclosure, the image capturing module 300 comprises a main portion 330. The main portion 330 is connected to a side of the first end 210. In the present embodiment, the main portion 330 is connected to a bottom of the first end 210. In some embodiments, the main portion 330 is connected to a side of the second end 220. The image capturing module 310 and the lens switch 320 are disposed in the main portion 330. The main portion 330 further comprises an opening 331. The camera unit 310 is aligned with the opening 331 in the main portion 330 so that the images from the viewing direction of the user can enter the camera unit 310 through the opening 331 and be received by the camera unit 310.

In detail, as shown in FIG. 5, the shielding element 321 is movably disposed between the opening 331 and the camera unit 310, and the shielding element 321 moves between the opening 331 and the camera unit 310 in a lateral displacement manner. The lateral displacement means that the shielding element 321 can move back and forth in a straight line.

In some embodiments, while the lens switch 320 is in the closed state, the entire opening 331 is blocked by the shielding element 321. At this time, from the front of the photographing glasses 100, the camera unit 310 cannot be seen through the opening 331, and only the shielding element 321 can be seen. In this state, people other than the user wearing the photographing glasses 100 can realize that the photographing glasses 100 is in a state that cannot be photographed and feel relieved.

In some embodiments, a color of a surface of the shielding element 321 facing the opening 331 is the same as a color of an outer surface of the main portion 330. Therefore, while the opening 331 is blocked by the shielding element 321, a uniform color is formed as a whole, so that people other than the user wearing the photographing glasses 100 can more easily observe that the photographing glasses 100 is in the state that cannot be photographed.

In some embodiments, the color of the surface of the shielding element 321 facing the opening 331 is significantly different from the color of the camera unit 310. For example, the camera unit 310 is generally a dark color, and the color of the surface of the shielding element 321 facing the opening 331 may be a bright color. In this way, people other than the user wearing the photographing glasses 100 can determine whether the photographing glasses 100 is in a photographing state by viewing the shielding element 321 with the bright color.

In some embodiments, as shown in FIG. 1 and FIG. 2, the main portion 330 further comprises a connecting section 3301 and a bending section 3302. The connecting section 3301 is configured to connect a side of the first end 210, and the bending section 3302 is bent from a side of the connecting section 3301 away from the first end 210 and extends to a side close to the connecting portion 230. The opening 331 is provided on the bending section 3302. The camera unit 310 and the lens switch 320 are disposed in the bending section 3302.

In some embodiments, the connecting section 3301 is configured to connect a side of the second end 220, and the bending section 3302 is bent from a side of the connecting section 3301 away from the second end 220 and extends to the side close to the connecting portion 230. In some embodiments, the connecting section 3301 and the bending section 3302 together form a V-shaped or 7-shaped main portion 330. In some embodiments, the connecting section 3301 is integrally formed with the bending section 3302. In some embodiments, the connecting section 3301 is connected to the first end 210 or the second end 220 by gluing, snap-fitting, locking, or the like.

It should be noted that a shape of the main portion 330 of the image capturing module 300 in the drawing is only an example and is not intended to be a limitation. In other words, the shape of the main portion 330 can be adjusted or changed according to different setting positions. For example, while the image capturing module 300 is disposed on the connecting portion 230, the shape of the main portion 330 may be rectangular accordingly.

In some embodiments, as shown in FIGS. 1, 2, 4, and 5, the main portion 330 further comprises a lens 332, and the lens 332 is disposed in the opening 331. In some embodiments, thicknesses of two sides of the lens 332 are not equal. In some embodiments, a thinner side of the lens 332 is located at a bending position between the connecting section 3301 and the bending section 3302.

In a first aspect of the photographing glasses 100 of the present disclosure, the image capturing module 300 may comprise a trigger unit (not shown in the figure) to control the movement of the shielding element 321. In this way, when the user triggers the trigger unit, the trigger unit can drive the shielding element 321 of the lens switch 320 to switch between the open state and the closed state. In some embodiments, the trigger unit may be a physical button or touch button disposed on the frame 200 or the main body 330, or a module triggered by software. For example, the photographing glasses 100 can be wirelessly connected to a portable electronic device, and the user can control the image capturing module 300 and the lens switch 320 through a software of the portable electronic device.

In a second aspect of the photographing glasses 100 of the present disclosure, the image capturing module 300 may comprise a driving module (not shown in the figure) to control the movement of the shielding element 321. In this way, while the driving module receives a signal, it can drive the shielding element 321 of the lens switch 320 to switch between the open state and the closed state. In some embodiments, the trigger unit is configured to generate a signal, and the signal is transmitted to the driving module so that the driving module drives the shielding element 321 of the lens switch 320 to move.

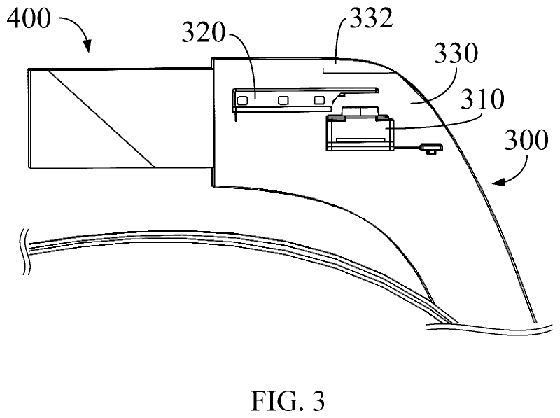

As shown in FIGS. 1 to 3, the photographing glasses 100 of the present disclosure may further comprise an information display module 400. The information display module 400 extends from the main portion 330 and is disposed on a side close to the connecting portion 230. For example, the information display module 400 extends from an end of the bending section 3302 away from the connecting section 3301 and is disposed in front of the user's viewing angle. After the user wears the photographing glasses 100, information displayed by the information display module 400 can be conveniently viewed from the viewing direction of the user. While the photographing glasses 100 of the present disclosure recognize and analyze the images viewed by the user in real time, the photographing glasses 100 can display corresponding information via the information display module 400 and provide the user with reference.

In summary, the photographing glasses 100 of the present disclosure can control the lens switch 320 through manual control or automatic control, so that the shielding element 321 of the lens switch 320 can be in the open state or the closed state. While the shielding element 321 is in the open state, the images from the viewing direction of the user can enter the camera unit 310 through the opening 331 and be received by the camera unit 310. While the shielding element 321 is in the closed state, the camera unit 310 is blocked and cannot receive the images from the viewing direction of the user. Therefore, it is possible to avoid privacy infringements that may be caused by improperly receiving surrounding images. In addition, people other than the user wearing the photographing glasses 100 can use the opening 331 of the photographing glasses 100 to distinguish whether the camera unit 310 is blocked by the shielding element 321. Therefore, the user wearing the photographing glasses 100 can make the shielding element 321 of the lens switch 320 in the closed state under certain circumstances, so that other people can clearly see that the opening 331 is blocked by the shielding element 321 and feel more at ease.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A photographing glasses, comprising:
a frame comprising a first end, a second end, and a connecting portion, wherein the second end is disposed opposite to the first end, and the connecting portion is configured to connect the first end and the second end; and
an image capturing module disposed at the first end, the second end, or the connecting portion of the frame;
wherein the image capturing module comprises a camera unit and a lens switch, the lens switch comprises a shielding element, and the shielding element is movably disposed on a side of the camera unit, while the lens switch is in an open state, the camera unit is exposed by the shielding element, and
while the lens switch is in a closed state, the camera unit is blocked by the shielding element,
wherein the image capturing module further comprises a trigger unit and a driving module, the trigger unit is configured to generate a signal, the driving module is configured to receive the signal to drive the lens switch to switch between the open state and the closed state.

2. The photographing glasses according to claim 1, wherein while the lens switch is in the open state, the camera unit is exposed by the shielding element in a viewing direction of a user, and the camera unit is configured to receive an image from the viewing direction of the user; while the lens switch is in the closed state, the camera unit is blocked by the shielding element in the viewing direction of the user, and the camera unit is blocked and cannot receive the image from the viewing direction of the user.

3. The photographing glasses according to claim 1, wherein the image capturing module comprises a main portion, the main portion is connected to a side of the first end, and the camera unit and the lens switch are disposed in the main portion.

4. The photographing glasses according to claim 3, wherein the main portion comprises an opening, the camera unit is aligned with the opening, and the shielding element is movably disposed between the opening and the camera unit.

5. The photographing glasses according to claim 4, wherein the shielding element moves between the opening and the camera unit in a lateral displacement manner.

6. The photographing glasses according to claim 4, wherein the main portion further comprises a connecting section and a bending section, the connecting section is connected to a side of the first end, the bending section is bent from the connecting section and extends to a side close to the connecting portion, the opening is provided on the bending section, and the camera unit and the lens switch are disposed on an inner side of the bending section.

7. The photographing glasses according to claim 4, wherein the main portion further comprises a lens disposed in the opening.

8. The photographing glasses according to claim 7, wherein thicknesses of two sides of the lens are not equal.

9. The photographing glasses according to claim 4, wherein a color of a surface of the shielding element facing the opening is the same as a color of an outer surface of the main portion.

10. The photographing glasses according to claim 9, wherein the color of a surface of the shielding element facing the opening is different from a color of the camera unit.

11. The photographing glasses according to claim 10, wherein the color of the camera unit is a dark color, the color of the surface of the shielding element is a bright color relative to the color of the camera unit.

12. The photographing glasses according to claim 3, further comprising an information display module, wherein the information display module extends from the main portion and is disposed on a side close to the connecting portion.

13. The photographing glasses according to claim 1, wherein the trigger unit comprises a physical button or a touch button disposed on the frame or the main body.

14. The photographing glasses according to claim 1, wherein the trigger unit comprises a module triggered by software of a portable electronic device in a wireless manner.

15. The photographing glasses according to claim 1, wherein the driving module is configured to drive the shielding element of the lens switch to move.
